(19) United States
(12) Patent Application Publication
(10) Pub. No.: US 2026/0262903 A1
(43) Pub. Date: Sep. 10, 2026

(54) DRYING TOOL

(71) Applicant: Broken Lantern Inc., St. Petersburg, FL (US)

(72) Inventor: Adrienne A. Van Tongerloo, St. Petersburg, FL (US)

(21) Appl. No.: 19/556,907

(22) Filed: Mar. 4, 2026

Related U.S. Application Data
(60) Provisional application No. 63/766,503, filed on Mar. 4, 2025.

(51) Int. Cl. A47L 13/20; A47L 13/14; B05C 17/02

(52) U.S. Cl. CPC A47L 13/20; A47L 13/14; B05C 17/0217

(57) ABSTRACT

A drying tool for marine, automotive, and other applications includes a buoyant, lightweight handle and a polyvinyl alcohol (PVA) foam roller for absorbing moisture from surfaces. The PVA foam roller is mounted on a roller shaft and is secured to the handle using a quick-release mechanism, enabling easy attachment and replacement. An integrated wringing mechanism removes excess moisture from the PVA foam roller. The handle may detachably connect to an extension pole for larger surfaces and extended-reach applications.

### CROSS-REFERENCE TO RELATED APPLICATIONS

This application is a U.S. non-provisional application which claims the benefit of priority of Provisional Patent Application 63/766,503, filed on Mar. 4, 2025, which is incorporated herein by reference.

### FIELD OF DISCLOSURE

The present invention relates generally to tools for drying surfaces and, in particular, relates to a lightweight, durable, and buoyant drying tool featuring an absorptive polyvinyl alcohol (PVA) foam roller as its drying component.

### BACKGROUND

Drying tools are essential in various industries and applications, ranging from household cleaning to automotive detailing and marine maintenance. Drying tools are designed to remove excess moisture from surfaces, enhancing cleanliness, preventing water spots, and reducing the risk of mold or mildew growth. Whether used for drying glass windows, vehicle exteriors, boat decks, shower enclosures, or removing liquid from an unexpected leak or burst pipe, an effective drying tool should maximize efficiency while minimizing labor and material waste. It is also essential that the drying tool maintains the integrity of the surface being dried or cleaned.

Conventional drying tools include tools such as mops, shammy mops, towels, rags, and squeegees. These conventional drying tools present significant limitations. For example, conventional tools typically do not remove all excess moisture. Mops and towels absorb moisture but become saturated quickly, requiring frequent wringing and replacement. Squeegees effectively remove water but lack the absorptive capacity to retain moisture, often pushing water to surrounding areas rather than fully eliminating it. Shammy mops are made of synthetic or fabric strips and tend to retain dirt and require continuous maintenance. Existing drying tools also generally fail to provide sufficient surface coverage, requiring multiple passes over the same area to achieve complete drying. They often have difficulty efficiently drying large surface areas such as those found in many vessels and vehicles, and in accessing hard-to-reach areas

In the marine industry, drying tools are frequently used to maintain dry surfaces in boats, yachts, and other watercraft. However, most traditional tools are not designed for use in wet, slippery environments. Another common problem with conventional drying tools, particularly those used in the marine industry, is that they are not buoyant. When accidentally dropped into the water, these tools sink, leading to unnecessary replacement costs and potential waste and environmental concerns. Furthermore, traditional tools often struggle to conform to curved surfaces, such as fiberglass hulls and boat decks, resulting in inefficient drying and streaking.

Another issue is that many conventional drying tools have rollers that are permanently affixed to the handle. This fixed configuration makes it difficult to clean, replace, or interchange the roller portion of the tool when needed. The purchase of an entirely new tool is often required once the roller portion of the tool becomes dirty, worn, or damaged. In high-use environments like yacht detailing, car washes, and hotel housekeeping, simple and efficient maintenance of drying tools is critical for maintaining efficiency.

Moreover, most traditional drying tools lack an integrated wringing mechanism, requiring manual twisting or external wringers to remove excess moisture. This inefficiency leads to increased labor, time, and discomfort for users. Hotel cleaning staff and yacht detailers, for example, must repeatedly dry shower enclosures throughout the day, and inefficient tools make the task more strenuous and time-consuming.

The description provided in this background section should not be assumed to be prior art merely because it is mentioned in or associated with this background section. This background section may include information that describes one or more aspects of the subject invention.

Accordingly, there is a need for a drying tool that provides a holistic approach to existing problems.

### SUMMARY

The present description includes one or more non-limiting embodiments for a device that is designed to efficiently remove moisture from various surfaces and comprises a handle, rod body, extension poles, and highly absorptive, non-abrasive, and sterile polyvinyl alcohol (PVA) foam roller. The device should be buoyant, lightweight, and durable to enhance usability and prevent accidental loss, such as in marine applications.

The device comprises a polyvinyl (PVA) foam roller configured to absorb moisture from a surface; a base frame comprising a first end configured to releasably attach to a rod body and also configured for user engagement, and a second end configured to rotably support the PVA foam roller; and a roller shaft configured with a quick release mechanism to enable attachment and detachment of the PVA foam roller on the base frame without use of a tool. The device may further comprise a handle comprising a first end configured for user engagement and a second end configured to releasably attach to the rod body, wherein the rod body is configured to releasably attach to the handle on one end and releasably attach to the base frame on the other end. The device may further comprise one or more extension poles configured to releasably attach on each end to the handle, the rod body, or the base frame. The handle, the rod body, the base frame, and the one or more extension poles are made of carbon fiber and the rod body and the one or more extension poles are hollow. The handle, the rod body, the base frame, and the one or more extension poles releasably attach by a releasable attachment mechanism, wherein the releasable attachment mechanism comprises spring-loaded push pins that are received in mating holes.

The first end of the base frame is formed as a neck, wherein the neck branches into roller support members extending from the neck at angles relative to the neck towards the second end of the base frame, wherein a roller mounting post extends inwardly from each support member of the roller support members. A side profile of the base frame has a bend and is not a straight line, wherein the bend is an obtuse angle between the first end and the second end of the base frame. An area between the roller support members and the roller shaft is open space with no support structure. The support members and the roller shaft form a triangular open space. The roller shaft connect to the roller mounting posts with the quick release mechanism, wherein the quick release mechanism comprises a pin connecting a roller mounting post on a first end of the roller shaft, wherein the pin is configured to enable the roller shaft to move at an angle from a roller mounting post of the roller mounting posts. The quick release mechanism also comprises a threaded cap on a roller mounting post and threads on an end opposite to the first end of the roller shaft, wherein the threaded cap is configured to screw on to the threaded end of the roller shaft and secure the roller shaft. The quick release mechanism may comprise a cross-sectional shape on an opposite the first end of the roller shaft, a shape or cavity on a roller mounting post complementary to the cross-sectional shape on the end opposite of the first end of the roller mounting shaft, and a cap, wherein the cap covers and secures a connection of the cross-sectional shape and the shape or cavity complementary to the cross sectional shape.

The handle may comprise a loop to hang the device when not in use. A cap with a loop may be removably attachable to the handle, the rod body, the base frame, or the one or more extension poles, wherein the loop is configured to hang the device when not in use. The device further comprises a wringing mechanism configured to slide along and compress the PVA foam roller to remove absorbed liquid from the PVA foam roller. The wringing mechanism may be configured to slide over the PVA foam roller and to apply pressure to remove the absorbed liquid from the PVA foam roller. The wringing mechanism may comprise rolling bearings configured to facilitate sliding movement from one side of the PVA foam roller to the other side of the PVA foam roller. The areas of the device configured for user engagement may comprise ergonomic grip.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawing. The drawings described herein are for illustrative purposes only of selected embodiments and not all possible implementations and are not intended to limit the scope of the present disclosure.

Other aspects and advantages of the invention will be apparent from the following description and appended claims.

FIG. 1A depicts an illustration of a front perspective view of an exemplary device.

FIG. 1B depicts an illustration of a rear perspective view of the exemplary device of FIG. 1A.

FIG. 2 depicts an illustration of a rear view of the exemplary device in FIG. 1A.

FIG. 3 depicts an illustration of a side view of the exemplary device in FIG. 1A.

FIG. 4 depicts an illustration of an exploded view of the exemplary device in FIG. 1A.

FIG. 5 depicts an illustration of a close-up view on the roller end of the exemplary device in FIG. 1A.

FIG. 6A depicts an illustration of a closed connection release mechanism of one side of the exemplary device in FIG. 5.

FIG. 6B depicts an illustration of an opened connection release mechanism of one side of the exemplary device in FIG. 5.

FIG. 7A depicts an illustration of a closed connection release mechanism of an opposite side (compared to FIGS. 6A and 6B) of the exemplary device in FIG. 5.

FIG. 7B depicts an illustration of an opened connection release mechanism of an opposite side (compared to FIGS. 6A and 6B) of the exemplary device in FIG. 5.

### DETAILED DESCRIPTION

The present description is drawn to a novel and unique drying tool designed to efficiently remove moisture from various surfaces and comprises a base frame, handle, rods/poles, and highly absorptive, non-abrasive, and sterile polyvinyl alcohol (PVA) foam roller. The device should be buoyant, lightweight, and durable to enhance usability and prevent accidental loss, such as in marine applications.

In accordance with non-limiting embodiments, the drying tool can be used in a variety of settings, such as, but not limited to, yachts, boats, vehicles, car washes, hotel housekeeping, etc. The drying tool comprises parts that may be interchangeable, replaceable, buoyant, and flexible in applicability. The design and modular nature of the drying tool provide many benefits, such as accessibility to hard-to-reach places, damage limitation to surfaces, low waste and replacement cost, environmental friendliness, and minimization of loss. Additionally, drying tool parts may be interchanged or replaced with only a user’s hands and without any additional tools like wrenches, screwdrivers, or pliers.

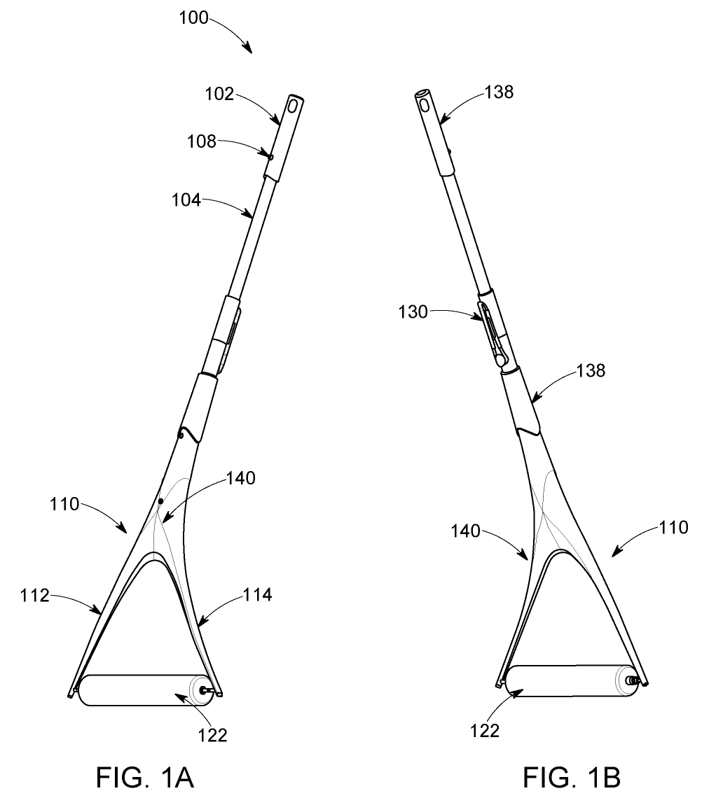

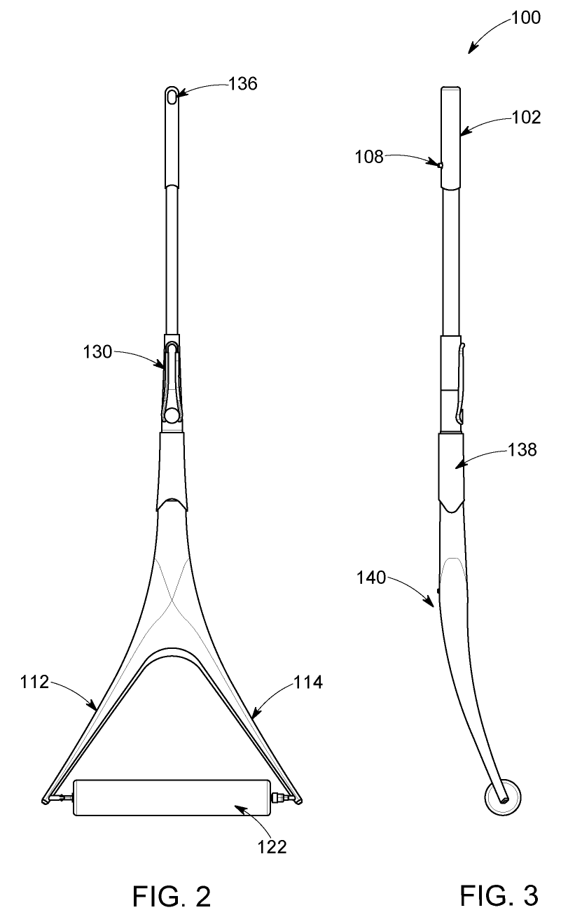

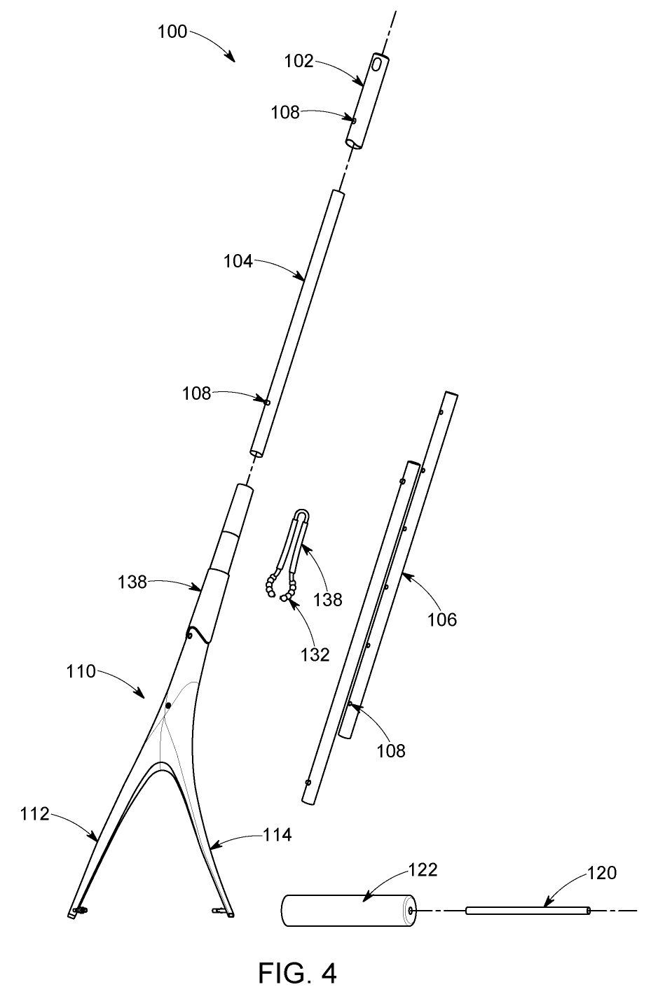

In accordance with non-limiting embodiments, FIGS. 1A and 1B show perspective views of tool 100. The front perspective view of tool or device 100 in FIG. 1A illustrates how an observer would see device 100 in use. The rear or back perspective view of device 100 in FIG. 1B illustrates how a user would see drying tool 100. FIG. 2 shows a rear view of device 100 and FIG. 3 shows a right side view of device 100. FIG. 4 shows an exploded view of the modular parts of device 100.

As best seen in FIG. 4, drying tool 100 comprises a handle 102, rod body 104, extension rods 106, a base neck 110 with support members 112, 114 securing a roller shaft 120, a roller 122, and squeegee/scraper 130 (e.g., as shown in FIG. 2). The drying tool 100 should be buoyant, lightweight, and durable to enhance usability and prevent accidental loss, particularly in marine applications. Because drying tools are frequently used on or near bodies of water, there is a significant risk that the tool may be dropped overboard. By ensuring that handle 102, roller 122, roller shaft 120, and body/extension poles 104, 106 are made from buoyant, lightweight, and durable materials (such as carbon fiber, PVA foam, lightweight polymers, or other low-density composites), drying tool 100 is easily retrievable if it falls into the water. PVA foam is also advantageous in that it is a non-abrasive material and protects the integrity of the surface being dried or cleaned. Furthermore, the use of buoyant materials prevents drying tool 100 from sinking and contributing to environmental pollution, an important consideration for marine and commercial drying applications. A lightweight design also reduces user fatigue, making it easier to maneuver tool 100 over large surface areas, such as the hull of a boat, vehicle exteriors, or other expansive surfaces that require drying or cleaning.

Handle 102 is constructed for stability, durability, and ease of use. In some examples, handle 102 is made of carbon fiber, which is a strong, lightweight, and buoyant material. Handle 102 maintains control over the direction and movement of roller 122 as well as the hygienic integrity of the PVA foam comprising roller 122. Handle 102 includes a first end that is configured for user engagement and a second end that is configured for releasable attachment of body/extension poles 104, 106. The first end configured for user engagement may be incorporated with an ergonomic grip foam 138 that is soft to the touch and non-slip, especially for wet environments. In some embodiments, the first end of handle 102 comprises a loop 136 or other means for hanging tool 100 when not in use. A loop may be incorporated permanently or removably attached, such as a silicone cover or rubber end cap that can be fitted onto handle 102. Advantageously, a removable cover or end cap may also fit on ends of poles 104, 106 and base frame 110. The second end of handle 102 may attach to a longer pole or rod body 104 or additional extension poles 106 to facilitate use of drying tool 100 in drying larger and more difficult to access surfaces.

In one example, contributing to the light weight and buoyancy of drying tool 100, poles 104, 106 are hollow and made of carbon fiber. A quick release mechanism is provided for easy and efficient attachment and detachment of handle 102 to and from body/extension pole 104, 106. In some examples, as best shown in FIG. 1A, FIG. 3, and FIG. 4, spring-loaded push pins or holes 108 are provided in handle 102 and body/extension poles 104, 106 to facilitate attachment and detachment. Pins 108 on body/extension pole 104, 106 are pushed in such that they are able to pass into the hollow interior of handle 102 and pop into mating holes formed in handle 102 to lock handle 102 and body/extension pole in place. Other suitable quick release mechanisms may alternatively be used. Similarly, push pins or holes 108 are provided on base frame 110 to facilitate attachment and detachment to poles 104 or 106.

Rod body 104 and extension poles 106 are configured to serve the same purpose of extending the length and reach by removable attachment between handle 102 and base neck frame 110. Rod body 104 may be a fixed length, but the fixed length may be produced in different lengths to fit the needs of users. Furthermore, extension poles 106 may work together to be adjustable in length by having multiple mating holes for push pins 108 to fit into and lock in place, thereby the overall length of tool 100 can be adjusted and used for different reach distances all in one tool without additional loose pieces to keep track of.

Base neck 110 comprises support members 112, 114 and is configured for attachment of PVA foam roller 122 via roller shaft 120. In nonlimiting examples, the first end of base neck 110 proximal to the user is configured for user engagement in addition to removable attachment of body/extension rods 104, 106. The first end of base frame 110, proximal to the user, is configured for gripping and handling and for releasable attachment to body/extension poles 104, 106 for adjusting length of reach. The first end may also incorporate an ergonomic grip cushion 138 that is soft touch and non-slip for wet environments. The gripping and handling portion may comprise a grip cushion 138 for comfort and reducing strain and fatigue while in use. The other or second end, distal to the user, is configured with support members 112, 114. Roller support members 112, 114 extend downwardly to form a Y-shaped neck at an angle of approximately 120 degrees relative to the first end of base neck 110. Advantageously, a user may use base frame 110 without handle 102 or body/extension rods 104, 106 for use in close quarters where there is minimal space to maneuver tools.

Furthermore, the side profile of base neck frame 110 is not straight, rather, it is bent as best seen in FIG. 3. As illustrated, rather than a 180 degrees straight line, there is an obtuse angle formed (best seen by the left side or right side of tool 100) between the single neck and the support members 112 and 114. The angle or bend 140 is incorporated in the area of base frame 110 where the base neck area branches into support members 112 and 114. The bend 140 may vary in location between the area of grip cushion 138 on base frame 110 and along support members 112 and 114. The bend 140 in the side profile provides leverage to apply pressure with less effort. The bend in the side profile is necessary to accommodate expanded PVA foam when fully saturated as PVA foam will expand significantly upon full absorption – up to twelve times its weight in liquid.

In nonlimiting embodiments, the bend 140 in the side profile of tool 100 is located on base frame 110 and not handle 102 or rods 104 and 106 due to ergonomics and lower production cost. When bend 140 is in base frame 110, handle 102 and rods 104 and 106 can be produced in a straight line of varying lengths rather than also including bent versions. When bend 140 is in base frame 110, the bend is in a location such that when a user uses tool 100 in different configurations, such as with just base frame 110, or base frame 110 with handle 102 and rod body 104, or with handle 102 and extension rods 106, the side profile bend 140 is in a beneficial location in every configuration. Advantageously, bend 140 in the side profile of tool 100 allows a user to reach and angle tool 100 in such a way to limit scratching or bumping ridges, protrusions, etc. in and around the area to absorb liquid. In some embodiments, thermoplastic polyurethane (TPU) bumpers are strategically placed on tool 100 on base frame 110 and support members 112, 114. Particularly advantageous placement of TPU bumpers on the outside of the Y-shape as well as along the interior of the Y-shape protect delicate surfaces, such as glass, fiberglass, teak wood, or metal, especially when foam roller 122 is removed and the interior area between support members 112, 114 and roller shaft 120 are more exposed to such surfaces. TPU bumpers are protective, flexible, designed to absorb shock, resist abrasion, and protect surfaces from impacts and damage.

In some embodiments, the particular angle of roller support members 112 and 114 relative to the first end of neck 110, as visible in the perspective views (FIG. 1A and FIG. 1B) and the rear view (FIG. 2) may vary depending on the application. Support members 112 and 114 branch out from a base neck and separate far enough to accommodate the width of mounting posts 116 and 118, roller shaft 120, and PVA foam roller 122. Some embodiments may resemble a wide U-shape or rectangular, bracket-like shape. In some embodiments, roller shaft 120 and support members 116 and 118 form a triangular shape, such as an isosceles triangle. Advantageously with the triangular shape, using the truss principle, a triangular shape distributes force directly to both ends of roller 122 (also ends of support members 112 and 114 furthest from the user) rather than in the center of a bracket-like shape where the force is further distributed to each side, losing some of the effort to apply pressure on a central, horizontal portion of a bracket-like shape.

In some embodiments, the space between roller shaft 120, PVA foam roller 122, and support members 116 and 118 is open space with nothing in that open space such that roller shaft 120 and PVA foam roller 122, including mounting posts 116, 118, are the only things between support members 112 and 118. Use of light, sturdy materials like carbon fiber permit an open space, unhindered from reinforcements or supportive structures, within the area between support members 116 and 118, PVA foam roller 122, and roller shaft 120. Any structures within this area may serve an ornamental value due to the strength of the material. Roller mounting posts 116 and 118 extend inwardly from the ends of roller support members 112 and 114 to rotatably and releasably support roller shaft 120 on which PVA foam roller 122 is mounted.

PVA foam roller 122 serves as the moisture-absorbing component of drying tool 100. Roller 122 is particularly suitable for drying large surfaces efficiently and without causing damage. Drying tool 100 may be used in various applications, such as marine applications for drying exterior boat surfaces, fiberglass hulls, teak decks, windows, bilges (which often have sea water or freshwater leaks and oil spills that can become trapped inside and create an extreme fire hazard), and other surfaces. In automotive detailing applications, drying tool 100 may be used to remove moisture from cars, trucks, luxury motor coaches, and other vehicles. In household, hotel, and other cleaning applications, drying tool 100 may be employed for drying showers, bathtubs, removing liquid from leaks or burst pipes, and other wet surfaces that require frequent drying. Drying tool 100 has a modular configuration, such that the size and dimensions of handle 102, roller 122, and body/extension rods 104, 106 may be customized based on the intended use, with smaller sizes and dimensions being generally preferable for interior drying applications, and larger sizes and dimensions providing better reach for exterior detailing and large surface areas.

Once PVA foam roller 122 has absorbed its maximum liquid capacity and before it is wrung or squeezed out using an integrated wringing mechanism, the user's hands, or another device, roller 122 effectively acts as a squeegee on surfaces because of the density of the PVA foam and the weight of the liquid inside its membrane. When roller 122 has absorbed the maximum amount of liquid it can hold, it becomes a solid block and effectively functions as a barrier that directs liquid in the direction of force applied. This is beneficial to drying and cleaning as the excess liquid can be pushed to the desired location until the excess liquid is squeezed or wrung out. Roller 122 may be wrung or squeezed to remove liquid from the foam and resume absorption of liquids when desired.

Roller 122 comprises an inner plastic tube surrounded by PVA foam. The inner plastic tube supports smooth rolling and maintains the rigidity of the roller. In nonlimiting embodiments, there are no additional layers of material beyond PVA foam that surround the inner plastic tube. In further nonlimiting embodiments, there is no reservoir or cavity to collect liquid, no channels to direct liquid in a certain direction, and no perforations for liquid drainage. Roller 122 may comprise various colors to distinguish between rollers 122 that have absorbed different liquids. For example, a user may desire to use a blue-colored roller 122 for water and a black-colored roller 122 for oil. When cleaning, a user may desire to use a red-colored roller 122 for window-type surfaces and a purple-colored roller 122 for floor surfaces.

Roller 122 is comprised of PVA foam, which is a synthetic sponge material characterized by a porous and three-dimensional open-cell structure that resembles the cellular composition of natural sea sponges. Unlike closed-cell foams, the interconnected nature of the cells in PVA foam allows for superior retention, absorption, and wicking properties, making it highly effective in moisture management applications. This physical structure contributes to a high filtering efficiency, allowing roller 122 to absorb and retain large amounts of liquid while remaining reusable after cleaning. In its dry state, PVA foam is hard and rigid, but upon exposure to water, it becomes soft and pliable while retaining its high moisture absorption properties. PVA foam is capable of absorbing up to twelve times its dry weight in water, and once saturated, it becomes flexible and soft, mimicking the texture and pliability of a natural sea sponge. PVA foam expands upon water absorption, with the wet volume increasing by approximately 20% compared to its dry volume, further enhancing its capacity for liquid retention. PVA foam is also able to absorb oil, fuel, and other liquids, such that it is useful in mitigating oil and fuel spills in nautical as well as automotive and other applications, thereby providing a positive environmental impact.

PVA foam exhibits superior mechanical strength and abrasion resistance compared to other materials, making it more durable for repeated use in demanding environments such as nautical vessels. The pore size and shape of the PVA foam may be modified during manufacturing to tailor it to specific applications and to have controlled absorption, filtration, or surface contact properties. When saturated, PVA foam maintains structural integrity at temperatures up to 90 degrees Celsius, resisting plastic deformation and ensuring reliability in high-temperature environments. In its natural state, PVA foam appears pure white, and can be pigmented to virtually any color with high colorfastness, allowing for customization based on intended applications

In some nonlimiting examples, the manufacturing process of PVA foam involves chemical insolubilization of a water-soluble porous structure, which enhances the stability and performance of the material. PVA foam is chemically resistant to dilute acids, strong alkalis, and most common detergents, ensuring its compatibility with a wide range of cleaning solutions. PVA foam inherently does not support bacterial or mold growth, and has antimicrobial properties that actively destroy microorganisms yet is generally non-toxic, biocompatible, and safe for skin contact, such as skin of humans and animals. Through this combination of high absorption capacity, mechanical durability, and chemical resistance, PVA foam provides a highly effective, reusable, and versatile material for drying applications in various industries, including marine and automotive detailing, and other commercial drying applications. Of particular importance to nautical applications, the buoyant properties carbon prevent drying tool 100 from sinking when accidentally dropped in water even when the PVA foam is fully absorbed with liquid.

As shown in the figures, FIGS. 1A-7B, PVA foam roller 122 is mounted on central roller shaft 120, which is made of a lightweight, durable, and buoyant material such as carbon fiber. Alternatively, other lightweight, durable, and buoyant materials such as polyvinyl chloride (PVC) may be used. Roller shaft 120 is secured to base neck 110 at both ends of roller shaft 120 by roller mounting posts 116, 118 extending from support members 112, 114. Drying tool 100 incorporates a quick-release system that enables fast removal and replacement of roller 122.

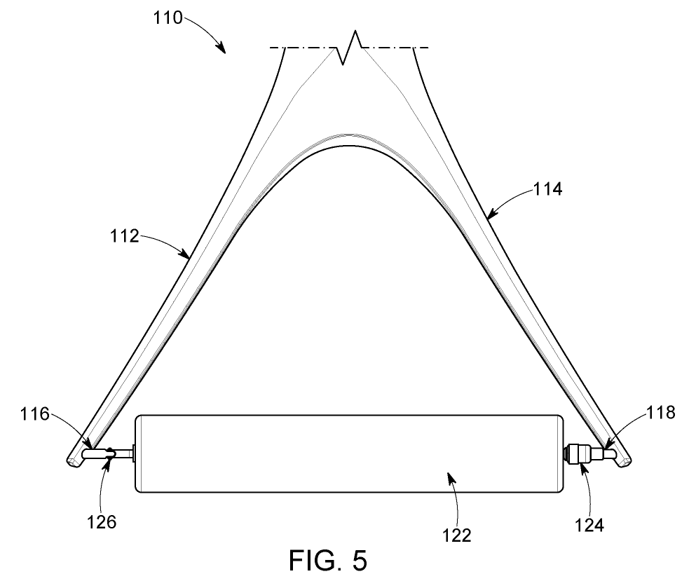

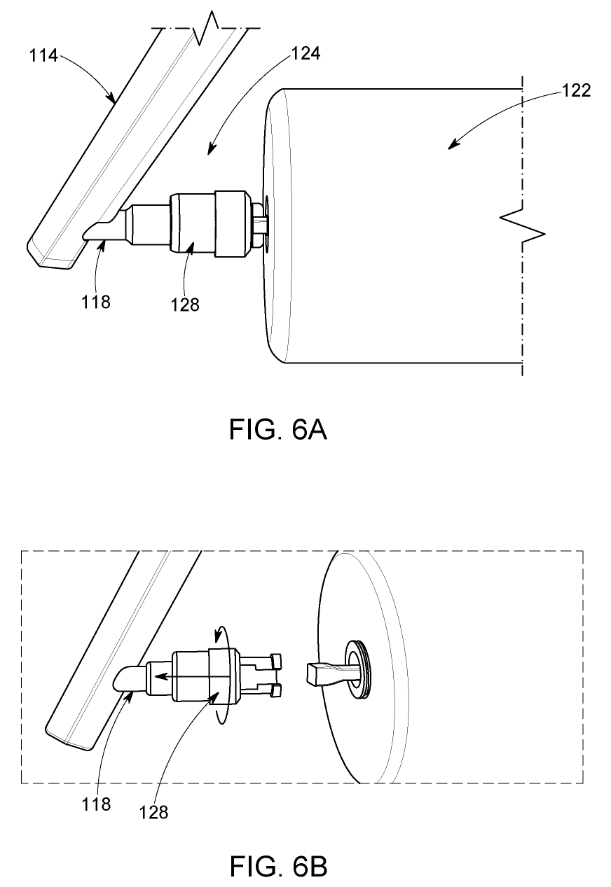

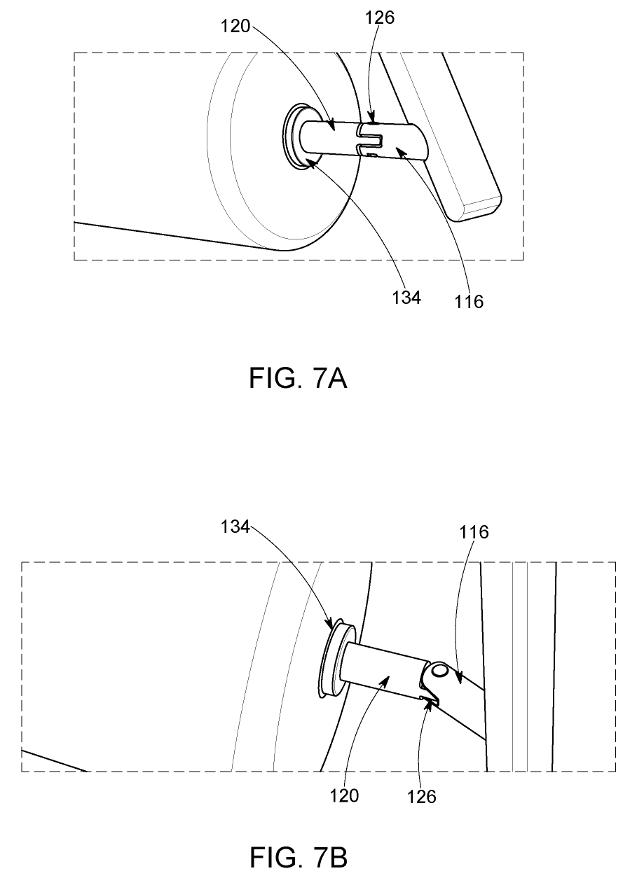

One non-limiting example of a quick-release system is illustrated in FIGS. 6A-6B and 7A-7B. As shown in FIGS. 5A and 5B, the releasable connection mechanism 124 comprises threads on an end of roller shaft 120 that extends past PVA foam roller 122, and a textured, threaded cap 128, configured to thread onto the threaded end of the roller shaft 120. When the roller shaft is locked-in position, as best seen in FIG. 6A, the threaded cap is secured over the threaded portion of roller shaft 120 and a portion of left mounting post 116. To release roller shaft 120 from left mounting post 116, as best seen in FIG. 6B, a user twists or rotates the threaded cap (as indicated by a circular movement arrow) and slides it away from the roller shaft 120 toward support member 112 on which left mounting post 116 extends. The texture on threaded cap 128 assists the user by increasing friction to twist or rotated the threaded cap 128. Alternatively, rather than or in addition to threads, the end of the roller shaft that extends past PVA foam roller 122 may be configured in a shape that fits into a mating hole on mounting post 116 and a cap 128 locks over the connection, for example, with a twist. FIG. 6B shows an example shape or protrusion on roller shaft 122 and a cavity exposed by cap 128 that has been rotated and moved toward mounting post 118. Additionally, cap 128 has a larger circumference compared to roller shaft 120 such that cap 128 also acts as a barrier or guard to keep roller 122 centered on roller shaft 120 and not reach support member 112 or mounting post 116. Advantageously, the connection mechanism 124 is manually and quickly attached and releasable without the aid of additional tools, thereby saving the user time and effort when PVA foam roller 122 is removed or secured on to roller shaft 120. Furthermore, there are no loose parts, such as screws, for a user to keep track of or lose.

As shown in FIGS. 7A and 7B, the opposite end of roller shaft 120 is shown connected to right mounting post 118 extending from support member 114 by connection mechanism 126. This end of roller shaft 120 connected to mounting post 118 integrates a pin, which may be spring-loaded. A guard 134 is also configured on roller shaft 120 to prevent roller 122 from bumping or reaching mounting post 118 and support member 114. FIG. 7A shows connection mechanism 126 when roller shaft 120 is locked in on connection mechanism 124 on the mounting post 116 side of roller shaft 120. FIG. 7B shows the connection mechanism 126 when roller shaft 120 is released from connection mechanism 126 on the mounting post 116 side of roller shaft 120. As can be seen in FIG. 7B, a pin allows the roller shaft 120 to bend at an angle from mounting post 118, thereby allowing roller 122 to slide from or onto roller shaft 120.

While one example of a quick release mechanism for drying tool 100 is illustrated in FIGS. 6A-7B, other suitable quick release mechanisms may alternatively be used. For instance, roller shaft 120 may be received within a recess or hole via an interference fit. Another example is a roller shaft end sitting in a U-shaped cradle with a latch for securing the roller shaft in place within the cradle. A push button release system may also be used in which a button, when pressed, disengages a locking detent within mounting posts 116, 118, allowing roller shaft 120 to slide freely. A magnetic retention system could be implemented, using embedded magnets within shaft 120 and mounting posts 116, 118 to provide a secure but easily detachable attachment. Yet another release system may comprise a squeezing of two parts to reveal an opening that releases roller shaft 120 from an enclosure. These and other variations may be employed to facilitate efficient roller replacement while maintaining secure attachment during operation without the use of additional tools or loose pieces.

The incorporation of a quick release mechanism allows a user to quickly swap rollers when a user desires roller 122 to be replaced or interchanged with another for different uses, such as a dry roller for a saturated roller, or a new roller for a damaged roller, or a non-soapy roller for a soapy roller. The easy and quick swapping of rollers also allows the user to save on cost by replacing only a roller or other modular part rather than the entire drying tool, which also minimizes pollution and waste added to the environment.

Drying tool 100 features an integrated wringing mechanism which allows users to remove or wring excess water from PVA foam roller 122 without manually squeezing it. As shown in FIGS. 1A-3, squeegee/scraper 130 comprises a handle comprising two arms configured to be joined on one end and used for gripping on the other end. The arms incorporate grip foam 138 that is soft touch and non-slip to aid in the comfort of holding and squeezing the arms together. The arms are configured in a curved manner at the gripping end such that the curves contour roller 122 and are pushed or pulled from one end of roller 122 to the other, compressing roller 122 and extracting absorbed moisture. In some embodiments, the area that would contact roller 122 may have bearings 132 to facilitate ease of movement of squeegee/scraper 130 across one side of roller 122 to the other side.

The body of squeegee/scraper 130 may be made of durable material that allows for enough flex to compress roller 122, such as, but not limited to, polished brass, other metals, and plastics. Squeegee/scraper 130 may be removably attached to drying tool 100, such as by clip, magnet, strap, etc. FIGS. 1A, 1B, 2, and 3 show an example of where a squeegee/scraper 130 may be removably attached to drying tool 100, but any other location (such as at neck 110 just above support members 112 and 114) may suffice as long as the location does not hinder use of drying tool 100.

A wring band may be provided, alternatively or in addition to squeegee/scraper 130, for removal of excess moisture from roller 122. A wring band may comprise a circular or oval-shaped band with an opening that receives roller 122. A wring band may be pushed from one end of roller 122 to the other, compressing roller 122 and extracting absorbed moisture. A wring band may be made of a durable, lightweight, and flexible material such as silicone, rubber, or plastic. In some examples, a wring band may be implemented as a silicone ring with small balls around its circumference to facilitate ease of movement along roller 122. In some examples, a wring band is removable from roller 122 and retainable on rod body 104 or base neck 110 so that it does not interfere with movement of roller 122 when drying tool 100 is in use. Integrated wringing mechanisms, such as those described above, facilitate continuous and efficient use of drying tool 100 by eliminating the need for external wringing mechanisms or manual compression of roller 122 to remove liquid.

Device 100 is designed to accommodate various roller and pole lengths to suit different drying needs. In some applications, a longer roller 122 may be approximately twelve to fourteen inches in length, with body or extension rod 104,106 having a length of about 110 inches. In other applications, a shorter roller 122 may be approximately eight to ten inches in length, with rod body 104 having a length of about 80 inches. In some cases, roller 122 may be even shorter, such as approximately six to eight inches in length, and may not require a rod body 104 or pole extensions 106 to be connected to base frame 110. A durable and ergonomic grip 138 may be provided on base neck 110 in the vicinity of the user engagement end above the Y-shaped support members 112, 114 which enable a user to grip and guide base frame 110 alone or as a second gripping area (in addition to grip 138 on handle 102) to better guide and apply pressure.

The above-described components of drying tool 100 interact to provide an efficient and effective drying solution. The absorptive properties of PVA foam roller 122, combined with the lightweight and buoyant handle 102, roller shaft 120, body/extension pole 104, 106 and the integrated wringing system, improve efficiency, reduce labor, and offer superior performance over conventional drying tools. The modular nature of the tool ensures that it can be adapted for various drying scenarios, making it an ideal choice for marine, automotive, household, and commercial applications. The disclosed drying tool offers a faster, more durable, and more convenient alternative to traditional drying methods, providing enhanced usability and performance across multiple industries.

While preferred and non-limiting embodiments of the present invention have been described, various other adaptations and modifications may be envisioned by those of ordinary skill in the art without departing from the scope and spirit of the invention. Many other advantages and benefits may be provided by the one or more systems and components described herein.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number) – (a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. The term “coupled to” as used herein may refer to a direct or indirect connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A device comprising:
a polyvinyl alcohol (PVA) foam roller configured to absorb moisture from a surface;
a base frame comprising a first end configured to releasably attach to a rod body and also configured for user engagement, and a second end configured to rotatably support the PVA foam roller; and
a roller shaft configured with a quick release mechanism to enable attachment and detachment of the PVA foam roller on the base frame without use of a tool.

2. The device of claim 1, further comprising a handle comprising a first end configured for user engagement and a second end configured to releasably attach to the rod body, wherein the rod body is configured to releasably attach to the handle on one end and releasably attach to the base frame on the other end.

3. The device of claim 2, further comprising one or more extension poles configured to releasably attach on each end to the handle, the rod body, or the base frame.

4. The device of claim 3, wherein the handle, the rod body, the base frame, and the one or more extension poles are made of carbon fiber, and wherein the rod body and the one or more extension poles are hollow.

5. The device of claim 3, wherein the handle, the rod body, the base frame, and the one or more extension poles releasably attach by a releasable attachment mechanism, wherein the releasable attachment mechanism comprises spring-loaded push pins that are received in mating holes.

6. The device of claim 1, wherein the first end of the base frame is formed as a neck, wherein the neck branches into roller support members extending from the neck at angles relative to the neck towards the second end of the base frame, and wherein a roller mounting post extends inwardly from each support member of the roller support members.

7. The device of claim 6, wherein a side profile of the base frame has a bend and is not a straight line, wherein the bend is an obtuse angle between the first end and the second end of the base frame.

8. The device of claim 6, wherein an area between the roller support members and the roller shaft is open space with no support structure.

9. The device of claim 8, wherein the roller support members and the roller shaft form a triangular open space.

10. The device of claim 6, wherein the roller shaft connects to the roller mounting posts with the quick release mechanism.

11. The device of claim 10, wherein the quick release mechanism comprises a pin connecting a roller mounting post on a first end of the roller shaft, wherein the pin is configured to enable the roller shaft to move at an angle from a roller mounting post of the roller mounting posts.

12. The device of claim 11, wherein the quick release mechanism comprises a threaded cap on a roller mounting post and threads on an end opposite to the first end of the roller shaft, wherein the threaded cap is configured to screw on to the threaded end of the roller shaft and secure the roller shaft.

13. The device of claim 11, wherein the quick release mechanism comprises a cross-sectional shape on an end opposite the first end of the roller shaft, a shape or cavity on a roller mounting post complementary to the cross-sectional shape on the end opposite of the first end of the roller shaft, and a cap, wherein the cap covers and secures a connection of the cross-sectional shape and the shape or cavity complementary to the cross-sectional shape.

14. The device of claim 2, wherein the handle comprises a loop to hang the device when not in use.

15. The device of claim 2, wherein a cap with a loop is removably attached to the handle, the rod body, the base frame, or one or more extension poles, wherein the loop is configured to hang the device when not in use.

16. The device of claim 1, further comprising a wringing mechanism configured to slide along and compress the PVA foam roller to remove absorbed liquid from the PVA foam roller.

17. The device of claim 16, wherein the wringing mechanism is configured to releasably attach to the device when not in use.

18. The device of claim 16, wherein the wringing mechanism comprises a scraper comprising two arms connected on one side and an opposite side wherein the two arms are configured to slide over the PVA foam roller and to apply pressure to remove the absorbed liquid from the PVA foam roller.

19. The device of claim 16, wherein the wringing mechanism comprises rolling bearings configured to facilitate sliding movement from one side of the PVA foam roller to the other side of the PVA foam roller.

20. The device of claim 2, wherein the areas configured for user engagement comprise ergonomic grip.
